(19) United States
(12) Patent Application Publication
(10) Pub. No.: US 2012/0044376 A1
(43) Pub. Date: Feb. 23, 2012

(54) FILTER CONVERSION DEVICE

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/914,941

(22) Filed: Oct. 28, 2010

(30) Foreign Application Priority Data
Aug. 19, 2010 (TW) 99127668

(51) Int. Cl. H04N 5/228

(52) U.S. Cl. 348/222.1; 348/E05.031

(57) ABSTRACT

A filter conversion device includes a first filter, a second filter, a motor, and a microswitch. The motor moves the first or second filter according to a control signal from a processor of the camera. The micorswitch is mounted adjacent to the first filter. A first terminal of the microswitch is grounded. A second terminal of the microswitch is connected to a power supply with a resistor and is connected to the processor of the camera with a connector. When the first filter contacts the microswitch, the microswitch turns on.

### CROSS-REFERENCE TO RELATED APPLICATION

Relevant subject matter is disclosed in the co-pending U.S. patent application (Attorney Docket No. US34485) having the same title, which is assigned to the same herein named assignee.

### BACKGROUND

1. Technical Field

The present disclosure relates to a filter conversion device.

2. Description of Related Art

Camera filters are transparent or translucent optical elements that alter the properties of light entering the camera lens for improving the image being captured. Filters can affect contrast, sharpness, highlight flare, color, and light intensity, either individually, or in various combinations. For cameras, which work in the light and in the dark, a conversion device is needed. The conversion device selects a filter in the light and a different filter for dark. However, the camera cannot ensure whether the filter conversion device works.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a filter conversion device.

FIG. 2 is a circuit diagram of the filter conversion device of FIG. 1.

FIG. 3 is a schematic diagram of the filter conversion device of FIG. 1 in another state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

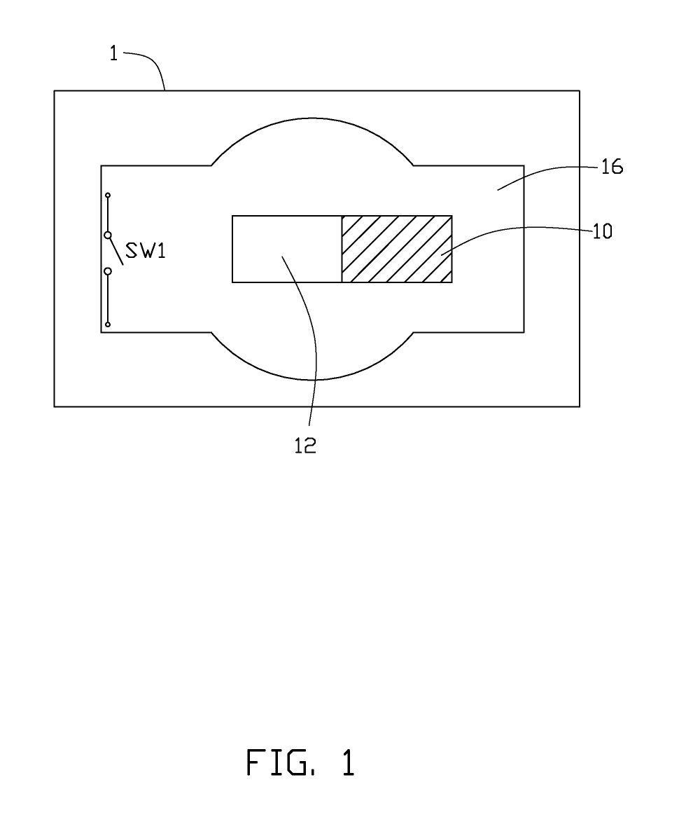

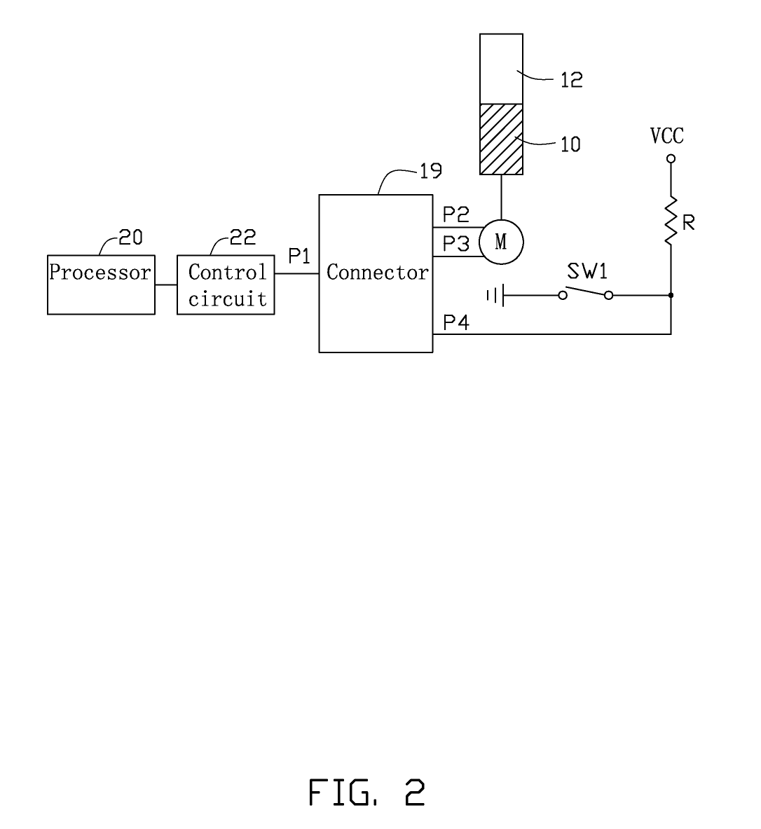

Referring to FIGS. 1 and 2, an exemplary embodiment of a filter conversion device includes a first filter 10, a second filter 12, a motor M, a body 16, a microswitch SW1, and a resistor R. The filter conversion device is set between a lens and an image sensor of a camera 1, to select the first filter 10 or the second filter 12 in the light or dark.

The motor M and the mircoswitch SW1 are connected to a processor 20 and a control circuit 22 of the camera with a connector 19. The control circuit 22 outputs different voltage signals to the motor M to make the motor M rotate forwards or backwards according to the processor 20. As a result, the first filter 10 and the second filter 12 are adjusted.

The microswitch SW1 is mounted on the body 16, and adjacent to a first end of the second filter 12. In other embodiments, the microswitch SW1 can be mounted adjacent to a first end of the first filter 10.

The connector 19 includes first to fourth terminals P1-P4. The first terminal P1 is connected to the processor 20 with the control circuit 22 of the camera. The second terminal P2 and the third terminal P3 are respectively connected to two terminals of the motor M. The fourth terminal P4 of the connector 19 is connected to a first terminal of the microswitch SW1. The first terminal of the microswitch SW1 is further connected to a power supply VCC with the resistor R. A second terminal of the microswitch SW1 is grounded.

In the light, the processor 20 controls the motor M to move the second filter 12 between the lens and the image sensor of the camera (FIG. 1). According to the principle of the microswitch, the microswitch SW1 is turned off because the second filter 12 is away from the microswitch SW1. At this time, the fourth terminal P4 of the connector 19 receives a high level signal and outputs the high level signal to the processor 20. As a result, the processor 20 determines that the second filter 12 is between the lens and the image sensor.

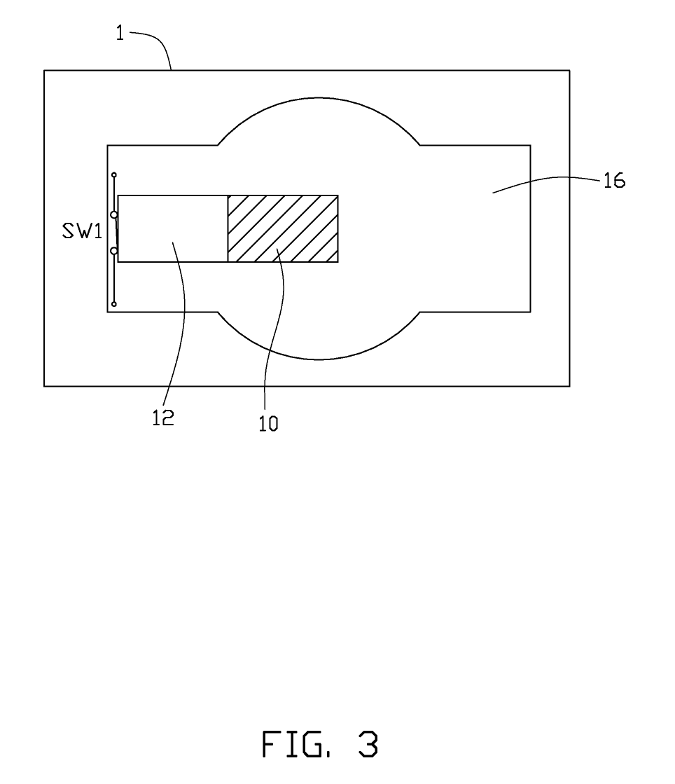

In the dark, the processor 20 controls the motor M to move the first filter 10 between the lens and the image sensor of the camera (FIG. 3). According to the principle of the microswitch, the microswitch SW1 is turned on because the second filter 12 contacts the microswitch SW1. At this time, the fourth terminal P4 of the connector 19 receives a low level signal and outputs the low level signal to the processor 20. As a result, the processor 20 determines that the first filter 10 is between the lens and the image sensor, as shown in FIG. 3.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A filter conversion device for a camera, the filter conversion device comprising:
a first filter;
a second filter;
a motor to move the first or second filter according to a control signal from a processor of the camera; and
a microswitch mounted adjacent to the first filter, wherein a first terminal of the microswitch is grounded, a second terminal of the microswitch is connected to a power supply with a resistor and connected to the processor of the camera with a connector, wherein when the first filter contacts the microswitch, the microswitch turns on.

2. The filter conversion device of claim 1, wherein the motor is connected to the processor with the connector.
